(19) United States
(12) Patent Application Publication
(10) Pub. No.: US 2007/0047443 A1
(43) Pub. Date: Mar. 1, 2007

(54) Channelized flow control

(75) Inventors: Shailendra S. Desai, San Jose, CA (US); Mark D. Hayter, Menlo Park, CA (US)

Correspondence Address: MEYERTONS, HOOD, KIVLIN, KOWERT & GOETZEL, P.C., 700 LAVACA, SUITE 800, AUSTIN, TX, 78701, US

(73) Assignee: P.A. Semi, Inc., Santa Clara, CA (US)

(21) Appl. No.: 11/212,075

(22) Filed: Aug. 25, 2005

(51) Int. Cl. H04J 1/16

(52) U.S. Cl. 370/235

(57) ABSTRACT

In one embodiment, a controller is configured to receive a flow control packet from a link partner on a communication medium. The flow control packet includes a channel indication that indicates one or more channels. The controller is configured to inhibit transmission of packets from at least one channel specified by the channel indication and to permit transmission of packets from channels not specified in the channel indication. The controller may also be configured to transmit the flow control packet in response to detecting a need to flow control one or more channels from the link partner.

### BACKGROUND

1. Field of the Invention

This invention is related to the field of network communication and especially Ethernet communication, and more particularly to flow control on networks.

2. Description of the Related Art

Networking of computers and other electronic devices has become ubiquitous. While a variety of networking standards exist, Ethernet is one of the most popular. In particular, Gigabit Ethernet and 10 Gigabit Ethernet is becoming widely used.

As the bandwidth of the network interfaces has increased, the likelihood that other factors in a system become bottlenecks to transmission has also increased. For example, memory latency (in reading packets for transmission or writing packets that have been received) can become an issue. In the Ethernet standard, once transmission of a packet begins, the entire packet must be transmitted without wait states or other flow control on the communication medium. If transmission is terminated prior to the end of the packet, the receiver will drop the packet as a bad packet and transmission must be restarted from the beginning of the packet. Thus, memory latency on the transmit side to read the packet from memory may be an issue since the packet may not be read quickly enough for complete transmission without any delays. Buffering in the network controller may be used to mitigate this effect, but it may not be feasible to include enough buffering in some cases. While the Ethernet standard specifies a maximum packet size of about 1500 bytes, many products implement larger packet sizes (e.g. 9 kilobytes or 16 kilobytes). Similarly, memory latency on the receive side may prevent writing the packet data successfully to memory before a buffer in the network controller overruns. Contention for access to the memory (e.g. by processors or other devices in a host system) increases the effective memory latency, further exacerbating the effect.

The Ethernet standard (and particularly Institute of Electrical and Electronic Engineers (IEEE) specification 802.3) permits the use of a flow control packet by a receiver. The flow control packet, which is also referred to as a pause packet, may be transmitted from a receiver to the transmitter if the receiver is temporarily unable to receive packets. The flow control packet directs the transmitter to cease transmission of any packets to the receiver for a period of time specified in the packet. The transmitter may transmit up to two more packets, and then ceases packet transmission for the requested time.

The flow control packet can be used to avoid dropping packets at the receiver. For example, if memory latency is causing the receiver to be unable to receive packets, the flow control packet may be used to insert delay in packet transmission so that the memory system can “catch up”.

Quality of service (QOS) metrics are becoming increasingly common on networks. Users can pay for different levels of service. Users for which low bandwidth communication is sufficient and for which communication latency is a lesser issue can pay for low priority service. For other users requiring higher bandwidth and/or dedicated bandwidth, higher priority service may be purchased (typically at higher prices). To manage different levels of service, the network controllers may implement separate buffers, or queues, for the different levels. The buffers may be even further subdivided according to user, transmitter, receiver, etc. To abstract the various divisions, a set of channels may be supported and priorities may be assigned to each channel.

The flow control packet may be problematic for supporting QOS. For example, if the low priority buffers used for low priority channels become full, a flow control packet may be transmitted. The high priority channels may still be capable of receiving packets, but the unavailability of the low priority channels causes the flow control packet to be transmitted anyway, stopping the flow of high priority packets as well. The flow control packet includes a well-known multicast address as the destination address, a source address that may be anything other than a multicast address or zero, a type field set to 8808 (in hexadecimal), an opcode field set to 0001 (in hexadecimal), and a pause time field coded to the time interval for which flow control is requested. The remainder of the packet is pad bytes to produce at least a minimum length packet.

### SUMMARY

In one embodiment, a controller is configured to receive a flow control packet from a link partner on a communication medium. The flow control packet includes a channel indication that indicates one or more channels. The controller is configured to inhibit transmission of packets from at least one channel specified by the channel indication and to permit transmission of packets from channels not specified in the channel indication. The controller may also be configured to transmit the flow control packet in response to detecting a need to flow control one or more channels from the link partner.

In another embodiment, a controller comprises a transmit circuit coupled to transmit packets on a communication medium to a link partner. Responsive to the controller receiving a flow control packet that includes a channel indication from the link partner on the communication medium, the transmit circuit is configured to inhibit transmission of packets from at least one channel specified by the channel indication and to permit transmission of packets from channels not specified in the channel indication.

In still another embodiment, a controller comprises a receive circuit coupled to receive packets transmitted by a link partner on a communication medium. The receive circuit is configured to receive packets into a plurality of channels, and to request transmission of a flow control packet to the link partner if the receive circuit is unable to receive packets in at least one channel of the plurality of channels. The flow control packet includes a channel indication field indicating the at least one channel.

In yet another embodiment, a method comprises receiving a flow control packet that includes a channel indication from a link partner on a communication medium; inhibiting transmission of packets from at least one channel specified by the channel indication; and permitting transmission of packets from channels not specified in the channel indication.

In a further embodiment, a system comprises a first controller, a second controller, and a communication medium coupled between the first controller and the second controller. Responsive to receiving a flow control packet from the second controller that includes a channel indication, the first controller is configured to inhibit transmission of packets from at least one channel specified by the channel indication and to permit transmission of packets from channels not specified in the channel indication.

### BRIEF DESCRIPTION OF THE DRAWINGS

The following detailed description makes reference to the accompanying drawings, which are now briefly described.

FIG. 1 is a block diagram of one embodiment of a system.

FIG. 2 is a flowchart illustrating operation of one embodiment of a network interface controller shown in FIG. 1 to generate a channelized flow control packet.

FIG. 3 is a flowchart illustrating operation of one embodiment of the network interface controller shown in FIG. 1 in response to receiving a channelized flow control packet.

FIG. 4 is a flowchart illustrating operation of one embodiment of the network interface controller shown in FIG. 1 for transmitting a packet.

FIG. 5 is a block diagram of a first embodiment of a channelized flow control packet.

FIG. 6 is a block diagram of a second embodiment of a channelized flow control packet.

FIG. 7 is a block diagram of a first embodiment of a channelized flow control packet.

FIG. 8 is a flowchart illustrating operation of one embodiment of the network interface controller shown in FIG. 1 for auto negotiation.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

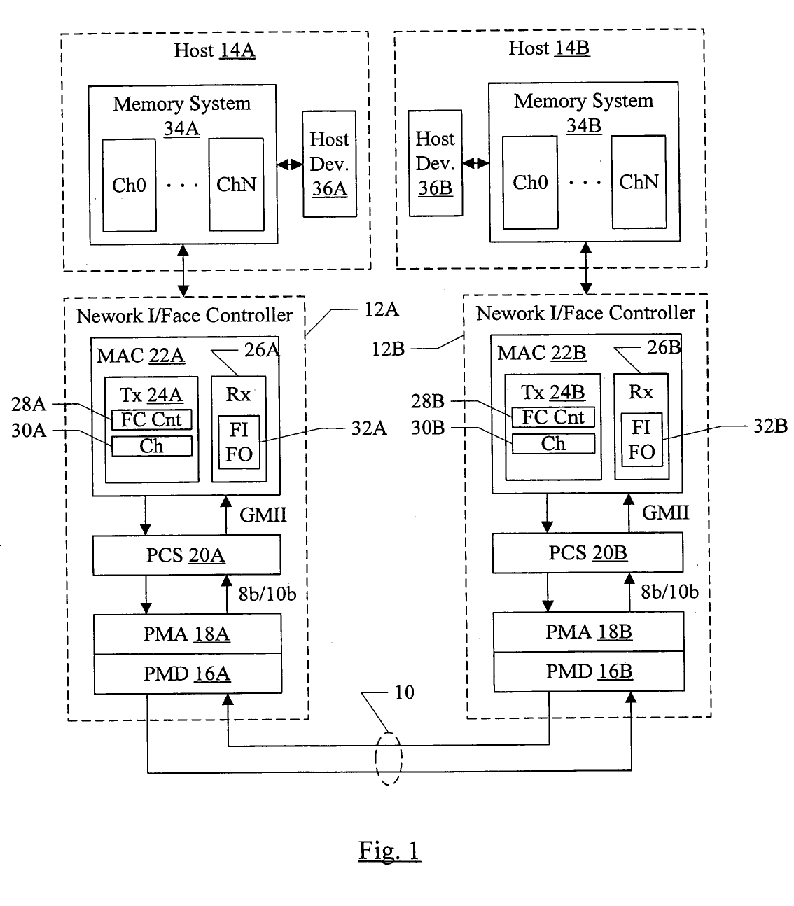

Turning now to FIG. 1, one embodiment of a networked system is shown. In the illustrated embodiment, the system includes a communication medium 10 over which network communications may be transmitted, network interface controllers 12A-12B coupled to the communication medium 10, and hosts 14A-14B coupled to the network interface controllers 12A-12B, respectively. In the illustrated embodiment, the network interface controller 12A includes a physical media dependent (PMD) layer 16A, a physical media attach (PMA) layer 18A, a physical coding sublayer (PCS) 20A, an a media access controller (MAC) 22A. The MAC 22A includes a transmit (Tx) circuit 24A and a receive (Rx) circuit 26A. The Tx circuit 24A includes one or more flow control counters 28A and one or more channel registers 30A, and the Rx circuit 26A includes one or more receive first-in, first-out (FIFO) buffers 32A. The PMD 16A is coupled to the communication medium 10 and to the PMA 18A, which is further coupled to the PCS 20A. The PCS 20A is coupled to the MAC 22A. The network interface controller 12B similarly includes a MAC 22B including Tx circuit 24B (which includes one or more flow control counters 28B and channel registers 30B) and Rx circuit 26B (which includes FIFO(s) 32B), PCS 20B, PMA 18B, and PMD 16B. The host 14A includes a memory system 34A and may also include other host devices such as host device 36A coupled to the memory system 34A. The host 14B may similarly include a memory system 34B and may also include other host devices such as host device 36B coupled to the memory system 34B. The memory systems 34A-34B may have various buffers or other memory regions for the channels supported for the packets (e.g. Ch0 to ChN in each of the memory systems 34A-34B in FIG. 1).

The network interface controllers 12A-12B (more briefly referred to below as controllers 12A-12B) are configured to transmit and receive packets on the communication medium 10. The network interface controllers 12A-12B may be link partners for each other on the communication medium 10. A link partner may include any device coupled to a communication medium 10 with a given device and capable of communicating over the communication medium 10 with the given device. In Gigabit/10 Gigabit (G/10 G) Ethernet, each physical link is established between a pair of devices which are link partners.

The controllers 12A-121B may be similar, and thus may operate in a similar fashion. The controller 12A (and portions thereof) will be described in more detail below, and the controller 12B may be similar. The controller 12B will thus be the link partner in this example.

The controller 12A may be configured to associate a channel with a given packet. On packet transmission, the channel is specified by software, by storing the packet in memory locations assigned to the channel. The Tx circuit 24A may select a channel for transmission, and may read the next packet to be transmitted on that channel from the memory system 34A. Alternatively, the host 14A may include direct memory access (DMA) circuitry that may select the channel and fetch the packet from the memory system 34A to the controller 12A (or the controller 12A may include the DMA circuitry). For packet reception, the Rx circuit 26A may include programmable packet classification filters (not shown) that may identify the channel for a received packet. The received packet may be written to memory locations in the memory system 34A assigned to that channel. Packets may include a channel ID field carrying the channel identifier, in some embodiments.

At various points in time, the controller 12A may detect that it is incapable of receiving packets on one or more channels. More particularly, in the illustrated embodiment, the Rx circuit 26A in the MAC 22A may detect that it is incapable of receiving packets on one or more channels. For example, the memory locations in the memory system 34A assigned to the channel(s) may be full with previously received packets, and thus there may be no location to store additional packets. In another example, the FIFO 32A may be divided into sections for each channel/priority level, or separate FIFOs may be included for each channel/priority level. The FIFO 32A for the channel/priority level may fill if memory latency is an issue. Other buffering at any point in the transfer to memory may fill for a given channel or priority level. As another example, one or more channels may be disabled (e.g. by software).

If the controller 12A detects that it is incapable or receiving packets on a channel or channels, the controller 12A may transmit a flow control packet to its link partner (the controller 12B) over the communication medium 10. The flow control packet may include a channel indication field, which may be coded to identify at least one channel. Responsive to the flow control packet, the link partner may inhibit transmission of additional packets on the channel(s) specified in the flow control packet. However, the link partner may still transmit other packets on other channels, if any. Since the flow control packet identifies one or more channels for which flow control is requested, the flow control packet may also be referred to as a channelized flow control packet.

By identifying the channels for which flow control is desired, packets on other channels may continue to be transmitted. Accordingly, overall through put may be increased since packets that can be transmitted are transmitted, even though some other channels may be blocked, in some embodiments. For example, if low priority channels are blocked, the higher priority channels may still transmit. Similarly, if higher priority channels are blocked, lower priority channels may still transmit.

In one embodiment, the channelized flow control packet may include a time field which specifies an interval of time during which the packet transmission is to be inhibited for the identified channels. The interval of time may begin when the link partner processes the flow control packet.

In the illustrated embodiment, the Tx circuit 24A may use the flow control counter(s) 28A and the channel register(s) 30A to monitor the progress of received channelized flow control packets and to inhibit transmission of packets on the corresponding channel(s). The Rx circuit 26A may receive the channelized flow control packet, and may provide the channel indication and the time specifier to the Tx circuit 24A. The Tx circuit 24A may initialize the flow control counter 28A responsive to the time field. Additionally, the Tx circuit 24A may update the channel register 30A to indicate the channel(s) identified by the channel indication in the channelized flow control packet. The Tx circuit 24A may inhibit transmission of packets from the identified channels until the specified time interval has expired.

The time interval may be measured in any desired units (e.g. seconds or fractions thereof, clock cycles, numbers of transfers on the communication medium 10, etc.). Once the counter 28A is initialized for the time interval, the Tx circuit 24A may update the counter 28A to reflect the passage of time until the time interval expires. For example, the Tx circuit 24A may decrement the counter 28A and may detect expiration of the interval when the counter reaches zero.

In some embodiments, more than one counter 28A and corresponding channel register 30A may be implemented. Such embodiments may be able to handle more than one flow control request at a time. In one implementation, there may be a counter 28A for each channel and no channel register 30A may be needed.

Generally, the Tx circuit 24A may include the circuitry for transmitting packets on behalf of the host 14A, and the Rx circuit 26A may include the circuitry for receiving packets on behalf of the host 14A. The MAC 22A may include various other circuitry implementing MAC layer protocols and operations, as needed.

The PCS 20A is coupled to the MAC 22A, and provides the line coding/decoding for the packets being transmitted. For example, G/10 G Ethernet specifies 8b/10b encoding for the data transmission on the communication medium. Accordingly, the PCS 20A receives data from the MAC 22A for transmission (e.g. packets transmitted by the Tx circuit 24A) and converts each 8 bit byte to a 10 bit symbol. Each 10 bit symbol received from the PMA 18A is converted to the corresponding 8 bit byte and provided to the MAC 22A (e.g. to the Rx circuit 26A). In the illustrated embodiment, the Gigabit Media Independent Interface (GMII) is used between the MAC and the PCS 20A. Other embodiments may use any interface.

The PMA 18A receives 8b/10b symbols from the PCS and converts them for transmission on the physical communication medium 10, and converts received signals to the 8b/10b symbols. For example, the symbols may be serially transmitted on one or more lanes of the communication medium 10. The PMD 16A includes the circuitry that physically drives and receives on the communication medium 10.

The communication medium 10 may comprise any medium over which packets may be transmitted between link partners. For example, in one embodiment, twisted pair copper cabling may be used. In another embodiment, optical fiber interconnect may be used. For Gigabit Ethernet, one lane of twisted pair or optical fiber may be provided in each direction. For 10 G Ethernet, 4 lanes of optical fiber may be used in each direction typically, although twisted pair is also possible in some cases. Other communication media may be used in other embodiments. Still further, wireless communication media (e.g. broadcast in the air) may be used.

The hosts 14A-14B may comprise any circuitry that uses the controllers 12A-12B to connect to a network (e.g. the communication medium 10 may be part of a network). As illustrated in FIG. 1, each host 14A-14B may include a respective memory system 34A-34B. The memory systems 34A-34B may comprise any semiconductor memory (e.g. random access memory (RAM) such as static RAM (SRAM), dynamic RAM (DRAM), synchronous DRAM (SDRAM), double data rate (DDR or DDR2) DRAM, Rambus DRAM, etc.). The memory systems 34A-34B may further comprise one or more memory controllers configured to interface to the memory. Additionally, the hosts 14A-14B may comprise any other desired circuitry, such as the host devices 36A-36B. The host devices 36A-36B may include processors, input/output (I/O) devices or interfaces, bridge circuits to other interfaces, caches, etc. The host devices 36A-36B may be coupled to the memory systems 34A-34B, and may create contention for access to the memory systems 34A-34B with the controllers 12A-12B. Such contention may lengthen effective memory latency for the controllers 12A-12B.

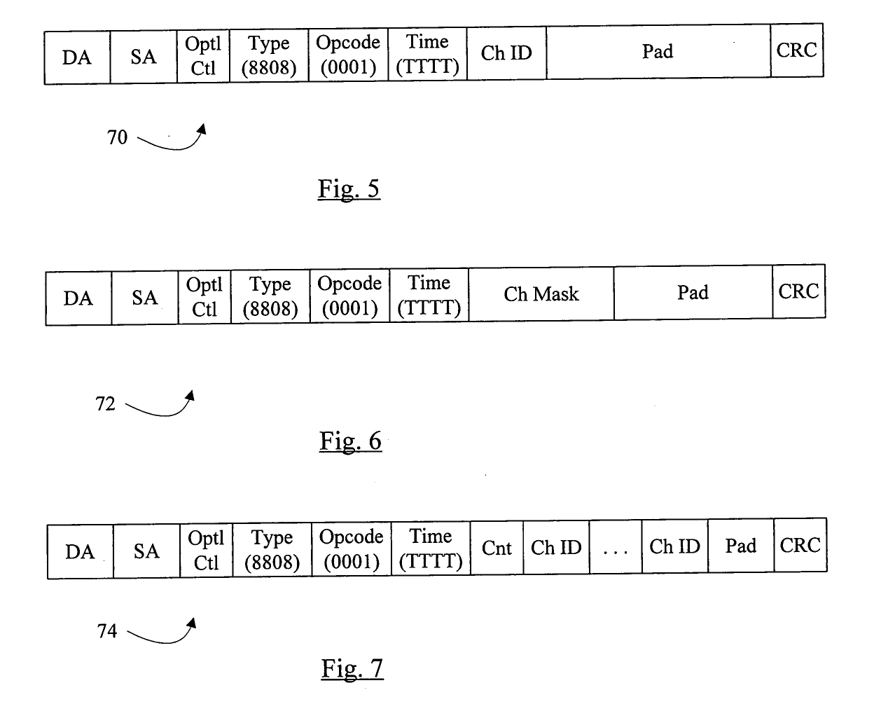

A flow control packet may generally be any packet which, when received in a device that communicates on the communication medium, is defined to cause the receiver to inhibit transmitting at least some packets to the initiator of the flow control packet. Exemplary packets are illustrated in FIGS. 5-7 and described in more detail below, but any packets may be used in various embodiments.

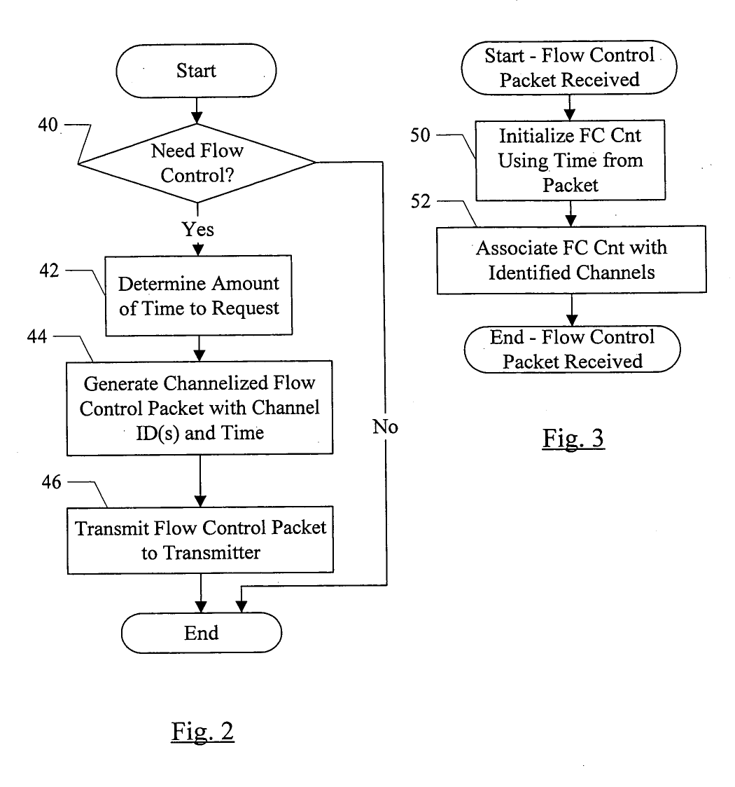

Turning now to FIGS. 2-4, flowcharts are show illustrating operation of one embodiment of the controller 12A (and similarly controller 12B). While the blocks are shown in a particular order for ease of understanding, any order may be used. Furthermore, blocks may be performed in parallel in combinatorial logic within the controller 12A. Blocks, combinations of blocks, or the flowchart as a whole may be pipelined over multiple clock cycles.

FIG. 2 is a flowchart illustrating operation of one embodiment of the controller 12A (and more particularly, the Rx circuit 26A and the Tx circuit 24A, in the embodiment of FIG. 1) for generating a channelized flow control packet. While the Rx circuit 26A and Tx circuit 24A are described as implementing various operations, other circuitry in the controller 12A may implement any operation.

The Rx circuit 26A may detect that flow control is needed for one or more channels (decision block 40). Flow control may be needed due to lack of memory locations for the channel, lack of buffer space, memory latency, disabled channels, etc. If flow control is needed (decision block 40, “yes” leg), the Rx circuit 26A may determine the interval of time to request (block 42). For example, the Rx circuit 26A may be programmed with an interval to request. The interval may be determined based on an estimate of the amount of time needed for memory locations/buffer locations to become available again. Any mechanism for determining the time interval may be used. The Rx circuit 26A may generate the channelized flow control packet using channel identifiers corresponding to the one or more channels and the time interval determined by the Rx circuit 26A (block 44). Alternatively, the Rx circuit 26A may provide the channel identifiers and the time to the Tx circuit 24A, which may generate the packet. The Tx circuit 26A may transmit the channelized flow control packet to the transmitter (e.g. the link partner) (block 46).

FIG. 3 is a flowchart illustrating operation of one embodiment of the controller 12A (and more particularly, the Rx circuit 26A and the Tx circuit 24A, in the embodiment of FIG. 1) in response to receiving a channelized flow control packet. While the Rx circuit 26A and Tx circuit 24A are described as implementing various operations, other circuitry in the controller 12A may implement any operation. The Rx circuit 26A may inform the Tx circuit 24A that a channelized flow control packet has been received, and may provide the time interval specified in the packet and the channel indication from the packet to the Tx circuit 24A. The Tx circuit 24A may initialize the flow control counter 28A using the time from the packet (block 50), and may associate the counter with the channels identified in the channel indication (e.g. by writing the channel indication or another representation of the identified channel to the channel register 30A) (block 52).

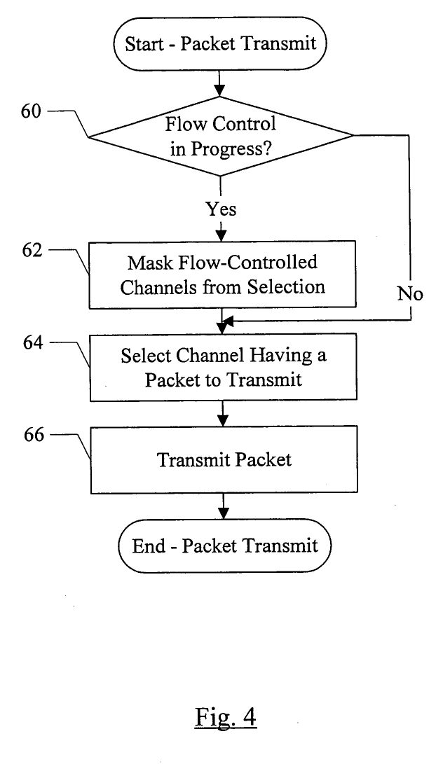

FIG. 4 is a flowchart illustrating operation of one embodiment of the controller 12A (and more particularly the Tx circuit 24A, in the embodiment of FIG. 1) to transmit a packet. While the Tx circuit 24A is described as implementing various operations, other circuitry in the controller 12A may implement any operation.

If flow control is currently in progress (e.g. a flow control counter 28A is non-zero) (decision block 60, “yes” leg), the Tx circuit 24A may mask the channels that are flow controlled (as indicated in the channel register 30A) so that the flow-controlled channels are not selected (block 62). If flow control is not currently in progress (decision block 60, “no” leg), no masking may be performed and all channels may be eligible for selection. The Tx circuit 24A may select a non-masked channel that has a packet to transmit (block 64), and may transmit the packet (block 66). Selection of a channel, when more than one channel has a packet to transmit, may be performed in any fashion (e.g. round-robin, weighted round-robin, priority, combination of priority and round-robin or weighted round-robin, etc.).

It is noted that the Tx circuits 24A-24B are described as transmitting packets and the Rx circuits 26A-26B are described as receiving packets. As described above, in the illustrated embodiment of FIG. 1, the packets may pass through the PCS 20A-20B, the PMA 18A-18B, and the PMD 16A-16B in between the MACs 22A-22B. The Tx circuits 24A-24B may be coupled to transmit packets (possibly through other circuitry such as the PCS, PMA, and PMD circuitry) on the communication medium 10. Similarly, the Rx circuits 26A-26B may be coupled to receive packets (possibly through other circuitry such as the PCS, PMA, and PMD circuitry) from the communication medium 10.

FIGS. 5-7 illustrate various embodiments of a channelized flow control packet that may be used in some embodiments of the system shown in FIG. 1. The embodiments of FIGS. 5-7 may be compatible with the currently-defined flow control packet. That is, if the link partner does not implement channelized flow control packets, the link partner may interpret the packet as a flow control packet without channelization, and may flow control all channels in response to the packet. Particularly, the channel indication field or fields may be used in place of pad bytes in the standard flow control packet, in one embodiment.

FIG. 5 is a first embodiment of the channelized flow control packet 70. In the embodiment of FIG. 5, the packet 70 includes a destination address field (DA), a source address field (SA), an optional control field (Optl Ctl), a type field (Type), an opcode field (Opcode), a time field (Time), a channel identifier field (Ch ID), pad bytes (Pad), and a cyclical redundancy check (CRC) field.

The destination address field may be coded to a well-known multicast address. For example, the address may be 01-80-C2-00-00-01 (in hexadecimal digits) in one embodiment that is compliant with the IEEE 802.3 standard. The source address field may be coded to anything but a multicast address or zero. In some embodiments, the source address assigned to the node may be used. The optional control field may include a packet length and other fields specified in the IEEE 802.3 standard. The type field may be coded to 8808 (hexadecimal) in the illustrated embodiment, and the opcode field may be coded to 0001 (hexadecimal). The time field may comprise four hexadecimal digits representing the time interval. The channel identifier field may be coded with a channel ID of the channel for which the flow control is requested (e.g. the channel number). Thus, the embodiment of FIG. 5 may be used to request flow control for one channel, and the channel indication field may comprise the channel identifier field for this embodiment. The pad bytes may include any data, and may be used to ensure that the packet 70 is at least minimum length. The CRC field stores a CRC calculated over the packet.

FIG. 6 is a second embodiment of the channelized flow control packet 72. In the embodiment of FIG. 6, the packet 72 includes the destination address field (DA), the source address field (SA), the optional control field (Optl Ctl), the type field (Type), the opcode field (Opcode), the time field (Time), the pad bytes (Pad), and the cyclical redundancy check (CRC) field, similar to the packet 70. The packet 72 also includes a channel mask field (Ch Mask). The channel mask field may comprise a bit mask with a bit for each possible channel. One state of the bit may indicate that the channel is flow-controlled by the channelized flow control packet 72, and the other state may indicate that the channel is not flow-controlled by the channelized flow control packet 72. For example, the set state may indicate flow-controlled and the clear state may indicate not flow-controlled, or vice versa.

The embodiment of FIG. 6 may permit any combination of channels to be specified in a channelized flow control packet 72. The size of the channel mask field may depend on the number of channels that are to be supported. For example, eight bytes may provide 64 bits, for 64 channels. Any number of channels may be supported in other embodiments. Thus, in this embodiment, the channel indication field may comprise the channel mask field.

FIG. 7 is a third embodiment of the channelized flow control packet 74. In the embodiment of FIG. 7, the packet 74 includes the destination address field (DA), the source address field (SA), the optional control field (Optl Ctl), the type field (Type), the opcode field (Opcode), the time field (Time), the pad bytes (Pad), and the cyclical redundancy check (CRC) field, similar to the packet 70. The packet 74 also includes a count field (Cnt) and a set of channel identifier fields (Ch ID). The count field may be coded to indicate the number of channel identifier fields that are included in the packet 74 (e.g. up to a maximum size that consumes all of the pad bytes in the packet 74). The channel identifier fields follow the count field, each channel identifier field having a channel identifier indicating one of the channels for which flow control is being requested. Thus, in this embodiment, the channel indication field may comprise the count field and the channel ID fields. In another alternative, the count field may not be included and a fixed number of channel ID fields may be included (e.g. the number that may be included in the pad bytes). In such an embodiment, unused channel ID fields in a given channelized flow control packet 74 may be coded to a value that indicates no channel is identified, or the same channel number may be included in several channel ID fields to provide a value in the fields.

While the embodiments illustrated in FIGS. 5-7 are compatible with the IEEE 802.3 specification, other embodiments may be compatible with non-IEEE 802.3 Ethernet encapsulation. Additionally, while the embodiments of FIGS. 5-7 have been defined for backward compatibility, so that a link partner that does not implement channelized flow control interprets the packet as a standard flow control packet, other embodiments may define the channelized flow control packet differently. In such cases, both flow control packets may be used. For example, the non-channelized flow control packet may be used if all traffic is to be flow-controlled, and the channelized flow control packet may be used if only certain channels are to be flow-controlled.

In some embodiments, the channelized flow control packet may be enabled or disabled dependent on whether or not the link partner supports the channelized flow control packet. For example, on Ethernet networks, an auto negotiation protocol is used at power up for link partners to determine each other's capabilities. After the standard auto negotiation, the link partners may exchange messages about other capabilities.

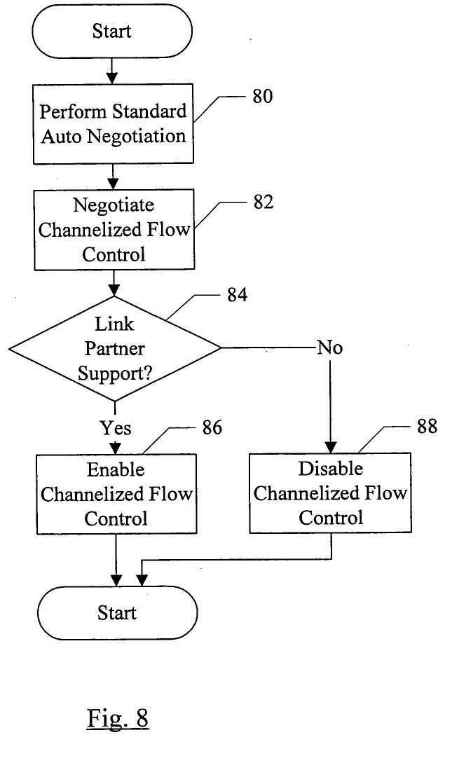

FIG. 8 is a flowchart illustrating operation of one embodiment of the controller 12A (and similarly controller 12B) for power up. While the blocks are shown in a particular order for ease of understanding, any order may be used. Furthermore, blocks may be performed in parallel in combinatorial logic within the controller 12A. Blocks, combinations of blocks, or the flowchart as a whole may be pipelined over multiple clock cycles.

The controller 12A may perform standard auto negotiation (block 80) followed by negotiation for channelized flow control (block 82). If the link partner supports channelized flow control (decision block 84, “yes” leg), the controller 12A may enable channelized flow control (block 86). Otherwise, the controller 12A may disable channelized flow control (block 88).

Numerous variations and modifications will become apparent to those skilled in the art once the above disclosure is fully appreciated. It is intended that the following claims be interpreted to embrace all such variations and modifications.

What is claimed is:

1. A controller comprising a transmit circuit coupled to transmit packets on a communication medium to a link partner, wherein, responsive to the controller receiving a flow control packet that includes a channel indication from the link partner on the communication medium, the transmit circuit is configured to inhibit transmission of packets from at least one channel specified by the channel indication and to permit transmission of packets from channels not specified in the channel indication.

2. The controller as recited in claim 1 further comprising a receive circuit configured to receive packets from the link partner, wherein the receive circuit is configured to request transmission of a flow control packet if the receive circuit is unable to receive packets on at least one channel.

3. The controller as recited in claim 1 wherein the flow control packet further includes a time field, and wherein the transmit circuit is configured to inhibit transmission of packets from the at least one channel for a period of time specified in the time field.

4. The controller as recited in claim 1 wherein the channel indication comprises at least one channel identifier.

5. The controller as recited in claim 4 wherein the channel indication comprises a plurality of channel identifiers including the at least one channel identifier.

6. The controller as recited in claim 5 wherein the channel indication comprises a count field indicating a number of the plurality of channel identifiers.

7. The controller as recited in claim 1 wherein the channel indication comprises a bit mask comprising a bit for each channel, wherein one state of the bit indicates that the corresponding channel is inhibited and wherein another state of the bit indicates that the corresponding channel is not inhibited.

8. A controller comprising a receive circuit coupled to receive packets transmitted by a link partner on a communication medium, the receive circuit configured to receive packets into a plurality of channels, and wherein the receive circuit is configured to request transmission of a flow control packet to the link partner if the receive circuit is unable to receive packets in at least one channel of the plurality of channels, and wherein the flow control packet includes a channel indication field indicating the at least one channel.

9. The controller as recited in claim 8 further comprising a transmit circuit coupled to transmit the flow control packet to the link partner on the communication medium.

10. The controller as recited in claim 8 wherein the flow control packet includes a time field, and wherein the receive circuit is configured to specify an interval of time during which transmission on the at least one channel indicated by the channel indication field is to be inhibited.

11. The controller as recited in claim 8 wherein the channel indication comprises at least one channel identifier.

12. The controller as recited in claim 11 wherein the channel indication comprises a plurality of channel identifiers including the at least one channel identifier.

13. The controller as recited in claim 12 wherein the channel indication comprises a count field indicating a number of the plurality of channel identifiers.

14. The controller as recited in claim 8 wherein the channel indication comprises a bit mask comprising a bit for each channel, wherein one state of the bit indicates that the corresponding channel is inhibited and wherein another state of the bit indicates that the corresponding channel is not inhibited.

15. A method comprising:
receiving a flow control packet that includes a channel indication from a link partner on a communication medium;
inhibiting transmission of packets from at least one channel specified by the channel indication; and
permitting transmission of packets from channels not specified in the channel indication.

16. The method as recited in claim 15 further comprising transmitting a flow control packet if unable to receive packets on at least one channel.

17. The method as recited in claim 15 wherein the flow control packet further includes a time field, and wherein inhibiting transmission of packets from the at least one channel is performed for a period of time specified in the time field.

18. The method as recited in claim 1 wherein the channel indication comprises at least one channel identifier.

19. The method as recited in claim 18 wherein the channel indication comprises a plurality of channel identifiers including the at least one channel identifier.

20. The method as recited in claim 19 wherein the channel indication comprises a count field indicating a number of the plurality of channel identifiers.

21. The method as recited in claim 1 wherein the channel indication comprises a bit mask comprising a bit for each channel, wherein one state of the bit indicates that the corresponding channel is inhibited and wherein another state of the bit indicates that the corresponding channel is not inhibited.

22. A system comprising:
a first controller;
a second controller; and
a communication medium coupled between the first controller and the second controller;
wherein the first controller, responsive to receiving a flow control packet from the second controller that includes a channel indication, is configured to inhibit transmission of packets from at least one channel specified by the channel indication and to permit transmission of packets from channels not specified in the channel indication.
